(19) United States
(12) Patent Application Publication
(10) Pub. No.: US 2026/0019125 A1
(43) Pub. Date: Jan. 15, 2026

(54) CONTROL MECHANISM FOR MULTI TRANSMISSION RECEPTION POINT COMMUNICATION

(71) Applicant: Nokia Technologies Oy, Espoo (FI)

(72) Inventor: Keeth Saliya Jayasinghe LADDU, Espoo (FI)

(21) Appl. No.: 18/994,765

(22) PCT Filed: Apr. 26, 2023
(86) PCT No.: PCT/FI2023/050228

§ 371 Date: Jan. 15, 2025

(30) Foreign Application Priority Data
Aug. 2, 2022 (FI) 20225697

(51) Int. Cl. H04B 7/06; H04B 7/024; H04B 7/0408; H04W 24/08

(52) U.S. Cl. CPC H04B 7/0626; H04B 7/024; H04B 7/0408; H04W 24/08

(57) ABSTRACT

An apparatus for use by a communication element or communication function capable of conducting multi transmission and reception point, TRP, operation, the apparatus comprising at least one processing circuitry, and at least one memory for storing instructions that, when executed by the at least one processor, cause the apparatus at least to obtain channel state information reporting configuration information for enabling group-based beam reporting based on prediction (S510), to receive a plurality of beams comprising at least one set of beams for measurement and at least one set of beams of prediction (S520), to determine an association of the received plurality of beams to a respective TRP of a communication network (S530), to measure resources from the at least one set of beams for measurement for identifying beam groups for simultaneous reception (S540), and to determine further beam groups usable for simultaneous reception by using a prediction model (S550), wherein the further beam groups comprise beams of the at least one set of beams for measurement and the at least one set of beams for prediction.

### BACKGROUND

### Field

Examples of the disclosure relate to apparatuses, methods, systems, computer programs, computer program products and (non-transitory) computer-readable media usable for controlling a multi transmission point using beam management. Specifically, examples of the disclosure relate to apparatuses, methods, systems, computer programs, computer program products and (non-transitory) computer-readable media usable for enabling an improved beam management allowing a communication element or communication function, such as a user equipment, to communicate with plural transmission reception points of a communication network.

### Background Art

The following description of background art may include insights, discoveries, understandings or disclosures, or associations, together with disclosures not known to the relevant prior art, to at least some examples of embodiments of the present disclosure but provided by the disclosure. Some of such contributions of the disclosure may be specifically pointed out below, whereas other of such contributions of the disclosure will be apparent from the related context.

The following meanings for the abbreviations used in this specification apply:

| | |
|---|---|
| 3GPP | 3^{rd} Generation Partnership Project |
| 4G | fourth generation |
| 5G | fifth generation |
| AI | artificial intelligence |
| CPU | central processing unit |
| CIR | configuration information request |
| CRI | CSI-RS resource indicator |
| CSI | channel state information |
| DL | downlink |
| DCI | downlink control information |
| eNB | E-UTRAN Node B |
| FNN | fully connected neural network |
| FR | frequency range |
| gNB | next generation node B |
| ID | identification |
| L1 | level 1 |
| LTE | Long Term Evolution |
| LTE-A | LTE Advanced |
| ML | machine learning |
| MU MIMO | multi user multiple input multiple output |
| NN | neural network |
| NW | network, network side |
| PDCCH | physical downlink control channel |
| PDSCH | physical downlink shared channel |
| RS | reference signal |
| RSRP | reference signal receiving power |
| RRC | radio resource control |
| Rx | receiver |
| SINR | signal to interference plus noise ratio |
| SGD | stochastic gradient descent |
| SSB | synchronization signal block |
| TRP | transmission reception point |
| Tx | transmitter |
| UE | user equipment |
| UL | uplink |

### SUMMARY

According to an example of an embodiment, there is provided, for example, an apparatus for use by a communication element or communication function capable of conducting multi transmission and reception point, TRP, operation, the apparatus comprising at least one processing circuitry, and at least one memory for storing instructions that, when executed by the at least one processor, cause the apparatus at least to obtain channel state information reporting configuration information for enabling group-based beam reporting based on prediction, to receive a plurality of beams comprising at least one set of beams for measurement and at least one set of beams of prediction, to determine an association of the received plurality of beams to a respective TRP of a communication network, to measure resources from the at least one set of beams for measurement for identifying beam groups for simultaneous reception, to determine further beam groups usable for simultaneous reception by using a prediction model, wherein the further beam groups comprise beams of the at least one set of beams for measurement and the at least one set of beams for prediction.

Furthermore, according to an example of an embodiment, there is provided, for example, a method for use in a communication element or communication function capable of conducting multi transmission and reception point, TRP, operation, the method comprising obtaining channel state information reporting configuration information for enabling group-based beam reporting based on prediction, receiving a plurality of beams comprising at least one set of beams for measurement and at least one set of beams of prediction, determining an association of the received plurality of beams to a respective TRP of a communication network, measuring resources from the at least one set of beams for measurement for identifying beam groups for simultaneous reception, and determining further beam groups usable for simultaneous reception by using a prediction model, wherein the further beam groups comprise beams of the at least one set of beams for measurement and the at least one set of beams for prediction.

According to further refinements, these examples may include one or more of the following features:
in case a prediction based on the prediction model results in an output of at least one further beam group, at least a part of the resulting further beam group may be reported in a predefined order to a TRP of the communication network, wherein the predefined order reflects a suitability level of the reported further beam groups for simultaneous reception;
when reporting at least a part of the resulting further beam group, additional parameters indicating communication properties of beams of the at least one further beam group may be included, wherein the communication properties may comprise at least one of a reference signal received power indication, a signal to interference plus noise ratio, a reliability metric associated to the prediction model used, and an indication of a capability value set;
a capability for supporting group-based beam reporting based on prediction may be reported to a TRP of the communication network, wherein the channel state information reporting configuration information may be received in response to the reporting of the capability;
for determining the association of the received plurality of beams to a respective TRP of a communication network, a predefined or received configuration indicating associations of received reference signals with at least two transmission points of the communication network may be used;
a beam may be represented by a downlink reference signal resource comprising at least one of a channel state information reference signal and a synchronization signal block resource, wherein the downlink reference signal resources may be grouped into groups each corresponding to a respective TRP;
the at least one set of beams for measurement may comprises downlink reference signals transmitted by a corresponding TRP, and the at least one set of beams for prediction may comprise downlink reference signals not transmitted by a corresponding TRP;
a beam group forming the identified beam group or the further beam group may comprise one of: a) beams corresponding to two TRPs or spatial filters, wherein at least one beam corresponds to a one TRP or spatial filter and another beam corresponds to a another TRP or spatial filter, or b) beams corresponding to only one TRP or spatial filter, wherein one sub-set of beams in the beam group are from the set of beams for measurement and another sub-set of beams in the beam group is determined from the set of beams for prediction;
as the resources from the at least one set of beams for measurement for identifying beam groups for simultaneous reception, at least one of a reference signal received power or a channel state information quantity may be measured on the basis of a signal transmission from the communication network;
the prediction model used for determining the further beam groups usable for simultaneous reception may be a machine learning prediction model using a neuronal network configuration having a plurality of neuronal network blocks including at least one of a fully connected neuronal network block, an activation function layer and a batch normalization layer.
the prediction model used for determining the further beam groups usable for simultaneous reception may be a non-machine learning prediction model;
as input data of the prediction model, beam measurements and identified beam groups for simultaneous reception may be used;
a prediction model which is to be applied may be determined on the basis of information provided by the obtained channel state information reporting configuration information;
at least a part of the determined further beam groups usable for simultaneous reception may be reported as uplink control information to the communication network;
a spatial filter adjusted for receiving beams identified or determined to be usable for simultaneous reception may be applied; and
the communication element or communication function may be comprised in a user equipment having multiple reception panels for simultaneously receiving beams from a plurality of TRPs of the communication network.

According to an example of an embodiment, there is provided, for example, an apparatus for use by a communication network control element or communication network control function acting as a transmission and reception point, TRP, for communicating with a communication element or communication function, the apparatus comprising at least one processing circuitry, and at least one memory for storing instructions that, when executed by the at least one processor, cause the apparatus at least to receive an indication of a capability of a communication element or communication function for supporting group-based beam reporting based on prediction, to transmit, to the communication element or communication function, channel state information reporting configuration information for enabling group-based beam reporting based on prediction.

Furthermore, according to an example of an embodiment, there is provided, for example, a method for use in a communication network control element or communication network control function acting as a transmission and reception point, TRP, for communicating with a communication element or communication function, the method comprising receiving an indication of a capability of a communication element or communication function for supporting group-based beam reporting based on prediction, transmitting, to the communication element or communication function, channel state information reporting configuration information for enabling group-based beam reporting based on prediction.

According to further refinements, these examples may include:
group-based beam reporting based on prediction may be triggered by triggering an aperiodic channel state information reporting to the communication element or communication function corresponding to the channel state information reporting configuration information.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some examples of disclosure related to embodiments are described below, by way of example only, with reference to the accompanying drawings, in which:

FIG. 1 shows a diagram illustrating an example of a communication network environment in which examples of the disclosure are implementable;

FIG. 2 shows a signaling diagram illustrating an example of a beam reporting procedure according to examples of the disclosure;

FIG. 3 shows a diagram of a beam measurement procedure according to examples of the disclosure;

FIG. 4 shows a diagram of a NN design for beam prediction according to examples of the disclosure;

FIG. 5 shows a flow chart of a processing conducted in a communication element or communication function according to some examples of the disclosure;

FIG. 6 shows a flow chart of a processing conducted in a communication network control element or communication network control function according to some examples of the disclosure;

FIG. 7 shows a diagram of a communication element or communication function according to some examples of the disclosure; and

FIG. 8 shows a diagram of a communication network control element or communication network control function according to some examples of the disclosure.

### DESCRIPTION OF EMBODIMENTS

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In order to improve communication network performance, such as throughput, robustness, accuracy or reliability, several developments are made. For example, in 5G networks, beamforming (or beam management) and MU MIMO are used in combination so as to increase the performance e.g. with regard to throughput and connection densities. Massive MIMO uses multi-antenna arrays and spatial multiplexing to transmit independent and separately encoded data signals, known as “streams”. By means of this, simultaneous communications with multiple user equipment (UE) over the same time period and frequency resource are possible. Beamforming, on the other hand, is used together with MIMO in order to focus communication beams more tightly towards individual UE, enabling higher connection densities and minimizing interference between individual beams.

For further increasing the performance, as one example, studies on Artificial Intelligence (AI)/Machine Learning (ML) for NR Air Interface are made, e.g. in Release 18 3GPP specification. The goal is to explore the benefits of augmenting the air-interface with features enabling improved support of AI/ML-based algorithms for enhanced performance and/or reduced complexity/overhead. As one goal, sufficient use cases shall be considered to enable identification of a common AI/ML framework, including functional requirements of AI/ML architecture, which could be used in various projects. It is also tried to identify areas where AI/ML may improve the performance of air-interface functions.

One initial use case includes beam management. For example, measures related to beam prediction in the spatial domain (BM-Case1) and beam prediction in the time domain (BM-Case2) for overhead and latency reduction are considered.

With regard to the above indicated use cases BM-Case1 and BM-Case2, for example, it is agreed that for AI/ML-based beam management, BM-Case1 is to be considered in connection with spatial-domain DL beam prediction for a set A of beams based on measurement results of a set B of beams, while BM-Case2 is to be considered for temporal DL beam prediction for a set A of beams based on the historic measurement results of a set B of beams. It is to be noted that beams in set A and set B can be in the same Frequency Range (FR). It is possible that for the use case BM-Case1, for example, set B is a subset of set A, or that beams of set A and set B are different. Generally, set B is for DL beam measurement and set A is for DL prediction.

For AI/ML input, it is considered that only L1-RSRP measurements are made based on set B, or alternatively that L1-RSRP measurement are made based on set B and assistance information. For example, usable assistance information may comprise one or more of the following: Tx and/or Rx beam shape information (e.g., Tx and/or Rx beam pattern, Tx and/or Rx beam boresight direction (azimuth and elevation), 3 dB beamwidth, etc.), expected Tx and/or Rx beam for the prediction (e.g., expected Tx and/or Rx angle, Tx and/or Rx beam ID for the prediction), UE position information, UE direction information, Tx beam usage information, UE orientation information, etc.

In communication networks, such as 5G new radio (NR) system, beam forming is used at both of a network side transmission reception point (TRP), such as a gNB, and a user equipment (UE) side. Beam management is used to acquire and maintain TRP and UE beams for communication. For example, beam management procedure is used to determine an appropriate Tx beam to be employed by the TRP and an appropriate Rx beam employed by the UE. The selected TRP Tx beam and UE Rx beam are then used for communication. The reference signal for beam management is, for example, a channel state information reference signal (CSI-RS) or a synchronization signal block (SSB).

For example, the TRP sends the UE a specific reference signal and the UE use the reference signal to measure the radio link quality. After measurement, the UE can report to the TRP which Tx beams are better for communications, and the reported content may include the Tx beam index or beam pair link index and the reference signal received power (RSRP). Considering the large number of beams, the overhead for reporting beam state may be high. In order to reduce this overhead, group based beam reporting has been proposed. The UE may report several, e.g. two, Tx beams which can be received simultaneously.

More specifically, in 3GPP, the following group-based beam reporting mechanisms are provided.

In Release15, group-based beam reporting (groupBasedBeamReporting) allows a UE to report two beams that can be received simultaneously by the UE. The UE is unaware that two beams are from the same TRP or different TRPs. For example, Release 15 reporting is valid for L1-RSRP or L1-SINR reporting (a CSI-ReportConfig with reportQuantity set to ‘cri-RSRP’, ‘ssb-Index-RSRP’, ‘cri-RSRP-CapabilitySetIndex’, ‘ssb-Index-RSRP-CapabilitySetIndex’, ‘cri-SINR’, ‘ssb-Index-SINR’, ‘cri-SINR-CapabilitySetIndex’ or ‘ssb-Index-SINR-CapabilitySetIndex’).

On the other hand, in Release17, group-based beam reporting allows a UE to report group(s) of two CRIs or SSBRIs selecting one CSI-RS or SSB from each of the two CSI resource sets for the report setting, where CSI-RS and/or SSB resources of each group can be received simultaneously by the UE. Here, the UE is aware of the beam to TRP association, and reported beams in a beam group are from different TRPs. Release 17 group-based beam reporting (groupBasedBeamReporting-r17) is supported by configuring the UE for two CSI resource sets. Otherwise, the number of CSI-RS resource sets being configured is limited to one. Release 17 reporting is valid for L1-RSRP reporting (a CSI-ReportConfig with reportQuantity set to ‘cri-RSRP’, ‘ssb-Index-RSRP’, ‘cri-RSRP-CapabilitySetIndex’, or ‘ssb-Index-RSRP-CapabilitySetIndex’).

In the following, different exemplifying examples of the disclosure will be described for illustrating a processing for improving simultaneous communication of a UE with multiple TRPs, wherein group-based reporting with AI/ML is used. For this, as an example of a communication network to which examples of the disclosure may be applied, a communication network architecture based on 3GPP standards for a communication network, such as 5G, is used, without restricting the disclosure to such an architecture, however. It is obvious for a person skilled in the art that examples of the disclosure may also be applied to other kinds of communication networks, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of the disclosure is related to a mobile communication network, but principles of the disclosure can be extended and applied to any other type of communication network, such as a wired communication networks as well.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele)communication network including a mobile communication system where some examples of the disclosure are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations such as communication elements, user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of the disclosure may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element or network functions, such as a UE, an TRP, like a gNB or other network elements or network functions, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

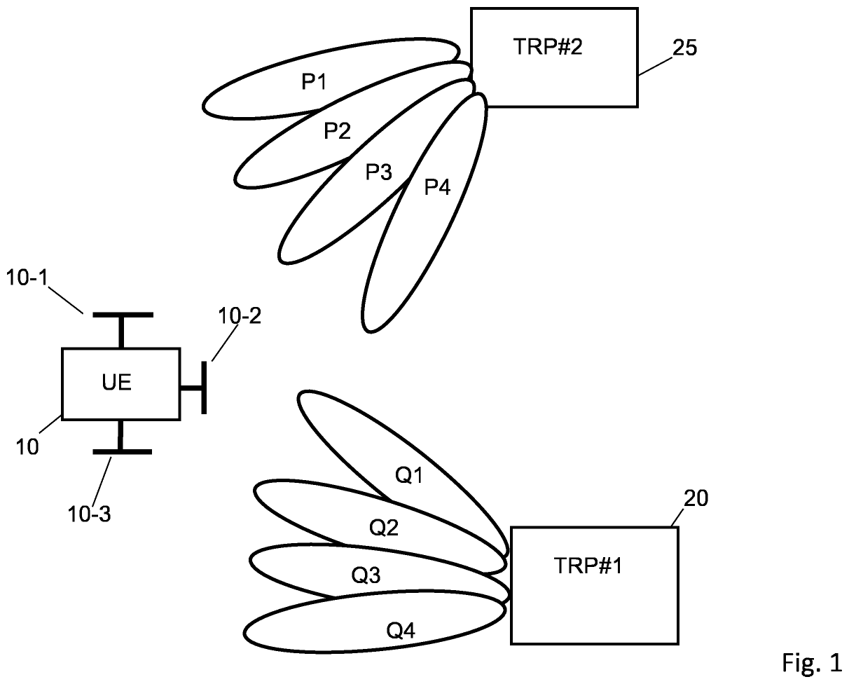

FIG. 1 shows a diagram illustrating an example of a communication network environment in which examples of the disclosure are implementable. Specifically, in FIG. 1, a UE 10 as an example of a communication element or communication function is shown which is located in a communication network which is represented by two TRPs, i.e. TRP #1 20 and TRP #2 25, which are, for example, communication network control elements or communication network control functions, such as gNBs.

The UE 10 is capable of conducting a simultaneous communication with a plurality of TRPs. For example, the UE 10 is equipped with multiple antenna panels 10-1, 10-2, and 10-3. The UE 10 uses the panels 10-1, 10-2, and 10-3 for supporting multi-TRP operations, wherein the multiple panels are used to communicate with one or more TRPs via beams such that simultaneous reception is facilitated.

The TRPs, i.e. TRP #1 20 and TRP #2 25, as shown in FIG. 1, each provide a plurality of beams, i.e. beams P1 to P4 in case on TRP #2 and beams Q1 to Q4 in case of TRP #1 20.

It is to be noted that the configuration illustrated in FIG. 1 is merely an example for illustrative purposes. There may be more UEs, more TRPs and more or less beams per TRP provided in an environment where multi-TRP communication is executed by UEs. Also, the number of panels per UE may be varying.

There are situations where not all beams are suitable for joint transmission towards a UE even though those beams can be separately received by the UE (via single TRP transmission). For example, in the configuration illustrated in FIG. 1, it can be assumed that the UE 10 cannot simultaneously receive beams Q1 and P3 (or P4) as they are received at the same panel 10-2.

In other words, it is difficult for a UE operating e.g. in FR2 to receive simultaneously from two TRPs unless the UE has different panels. Consequently, the benefit for the network of scheduling transmission on two (or more) beams is questionable unless it is known in advance that the UE can receive them.

In view of this, as described above, group-based beam reporting can be employed where beams are divided into two sets and reporting can be done for beam groups. However, in this connection, it is to be considered that the beams used by each TRP may separately follow beam refinement and pairs of beams (beam group) may be reported after such beam refinement stages per TRP. In general, each TRP has to transmit a large number of reference signals like SSBs and CSI-RSs, which cause overhead concerns as each beam is associated to a different SSB or CSI-RS resource. Also, overall beam reporting for group-based beam reporting may have a large latency as the time required for the TRPs and UE to complete the beam sweeping/refinement and selecting beam groups to support simultaneous transmission is usually conducted on the basis of multiple rounds of measurements.

According to examples of the disclosure, a procedure is provided which allows an improved beam management so that the communication network performance can be enhanced when a communication element or communication function, such as a UE, communicates with plural TRPs of a communication network. That is, according to examples of the disclosure, when considering for example the above described BM-Case1 (spatial domain beam prediction), a UE supporting multi-TRP operation (single DCI or multi-DCI), such as UE 10 in FIG. 1, reports beam pairs that the UE 10 can receive simultaneously. By means of the measures proposed in examples of the disclosure, the UE 10 is able to predict beam pairs for simultaneous reception. Thus, a reduced RS overhead and a reduced latency in the beam measurement and reporting can be achieved.

Specifically, according to examples of the disclosure, the following procedure is proposed. The principles underlying the examples of the disclosure are described with reference to FIG. 1 as an example of employing measures according to examples of the disclosure.

The UE 10 obtains configuration information, for example, from the communication network which are usable for a group-based beam reporting based on prediction. For example, corresponding configuration information is obtained when the UE 10 reports, to the communication network, its capability of supporting such a group-based beam reporting based on prediction. The group-based beam reporting based on prediction concerns an indication to the network that one or more beam pair(s) (or one or more beam group(s)) that support simultaneous communication (i.e. reception at the UE side) can be reported based on a beam prediction which is based, for example, on an algorithm, a specified method or implementation used at the UE side. Alternatively, there are other examples causing the UE 10 to obtain the configuration information, for example, when answering to a corresponding inquiry from the network, or on the basis of a preset configuration assuming, for example, that a UE attaching to the network is capable of supporting the group-based beam reporting based on prediction.

For example, the UE 10 receives, in response to a corresponding report, an CSI reporting configuration that enables the group-based beam reporting based on prediction. Furthermore, the UE 10 receives plural sets of beams, e.g. at least two sets of beams for measurements (referred to as set B1 and set B2) and at least two sets of beams for prediction (referred to as set A1 and set A2). Sets A1 and B1 are received from one TRP, e.g. TRP #1 20, while sets A2 and B2 are received from another TRP, e.g. TRP #2 25.

For example, according to some examples of the disclosure, a full measurement set (set B) of beams may be a super set containing a union of beams in set B1 and set B2. Furthermore, a full prediction set (set A) of beams may be a super set containing a union of beams in set A1 and set A2. According to some further examples of the disclosure, set B1 may be a subset of set A1, and set B2 may be a subset of set A2. In another variant, set B1 and set A1 may be different to each other, and set B2 and set A2 may be different to each other.

According to some examples of the disclosure, the UE 10 is configured to use a predefined or received configuration that indicates the association between a set of measurement/prediction beams (set A1/A2 and sets B1/B2) and a TRP, such as a TRP ID, a physical cell ID, or a CORESETPoolIndex (CORESET represents is a set of physical resources (i.e, a specific area on NR Downlink Resource Grid) and a set of parameters that is used to carry PDCCH/DCI). Alternatively, also a reference index applied for PDCCH/PDSCH reception can be used.

It is to be noted that according to some examples of the disclosure, sets of beams may be associated with each other. For example, set A1 and set B1 (or set A2 and set B2) may also be associated with each other based on the association defined between a set of beams and TRP/PCI/CORESETPoolindex (or with a reference index applied for PDCCH/PDSCH reception).

Moreover, according to some examples of the disclosure, the UE 10 measures resources from the measurement sets, i.e. set B1 and set B2, and use the beam measurements (e.g., L1-RSRP and beam index) to identify the beam pairs from set B1 and set B2 that are suited for simultaneous reception.

Then, the UE 10 determines additional beam groups or bam pairs that are suited or usable for simultaneous reception. This determination is conducted by using a prediction model. The prediction model uses at least the beam measurements (L1-RSRP and beam index) and identified beam groups/pairs from set B1 and set B2 as inputs for the prediction model. The additional beam groups/pairs may contain, for example:
a beam pair containing a beam from a prediction set (e.g. set A1) corresponding to one TRP/PCI/CORESETPoolindex and a beam from another prediction set (e.g. set A2) corresponding to another TRP/PCI/CORESETPoolindex,
a beam pair containing a beam from a measurement set (set B1 or set B2) corresponding to one TRP/PCI/CORESETPoolindex and a beam from a prediction set (set A2 or set A1) corresponding to other TRP/PCI/CORESETPoolindex, and
a beam pair containing a beam from a measurement set (e.g. set B1) corresponding to one TRP/PCI/CORESETPoolindex and a beam from another measurement set (e.g. set B2) corresponding to another TRP/PCI/CORESETPoolindex.

After the determination, the UE 10 reports the a predefined part of the determined beam pairs to the network, e.g. to the TRP #1 20. The predefined part comprises, for example, the best or most-suited beam pairs among the determined beam pairs in a preset order, e.g. from best-to-worst or worst-to-best. Moreover, the information sent to the network can comprise also other information, such as additional parameters. These parameters comprises, for example, one or more of the following: corresponding L1-RSRP/L1-SINR values, a reliability metric associated with the prediction, and capability value set indications. It is to be noted that corresponding parameters may also be omitted.

According to further examples of the disclosure, the UE 10 may also report beam pairs/groups corresponding to both identified (from set B1 and set B2) and determined beam groups/pairs (from set A1/B1 and set A2/B2).

Moreover, according to further examples of the disclosure, the UE 10 is configured to report a limited number of beam groups/pairs, and each group/pair may have at least two beams.

When the reporting of the determined beam pairs/groups is done, the UE 10 may apply different spatial filters for receiving a reported beam group/pair. Moreover, according to examples of the disclosure, based on reported beam groups/pairs, the UE 10 may be scheduled to receive simultaneous data transmission from plural TRPs simultaneously, wherein the corresponding reported beam pair is assumed to receive data.

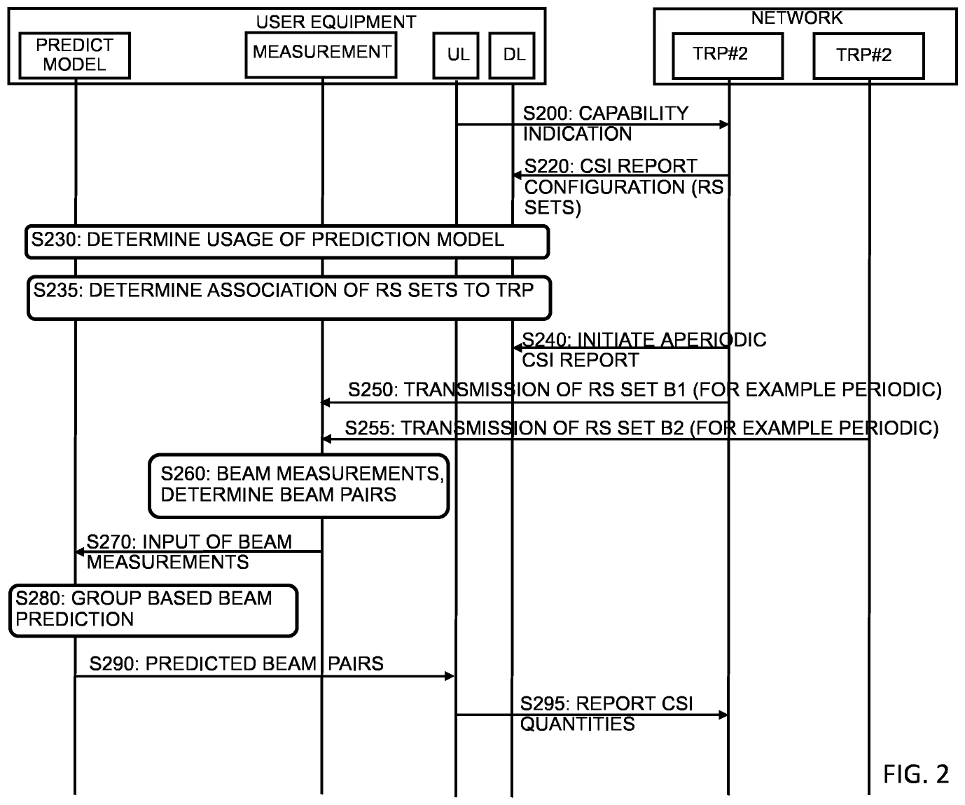

FIG. 2 shows a signaling diagram illustrating an example of a beam reporting procedure according to examples of the disclosure. Specifically, FIG. 2 provides one possible way of implementing the procedure described above. In the example shown in FIG. 2, it is assumed that periodic CSI-RS transmissions and CSI reporting configuration is associated with the aperiodic CSI triggering. This enables the beam prediction reporting in a dynamic manner considering measurements and predictions.

As shown in FIG. 2, a signaling between a UE (e.g. UE 10 in FIG. 1) and two TRPs (e.g. TRP #1 20 and TRP #2 25 in FIG. 1) is depicted. On the UE side, as signaling instances, an UL and a DL communication element, a measurement module for measuring signals received via beams, and a prediction model entity are provided.

In S200, the UE 10 sends to the network (e.g. TRP #1 20) a capability indication indicating that it supports group based beam reporting based on prediction.

In S210, the UE receives, e.g. via RRC, a configuration information, e.g. in the form of a CSI-ReportConfig that enables group-based beam reporting. In this connection, information are provided which enables the UE 10 to further define beam sets for measurements and beam sets for prediction, for example, up to four RS (reference signal) sets, where the CSI-ReportConfig may indicate the RS sets as CMR1 to CMR4 (i.e. set A1/A2/B1/B2, as described above).

In S230, the UE 10 determines, on the basis of the received CSI-reportConfig information, that a prediction model can be applied for group-based beam reporting, as well as related RS sets for measurements and predictions.

In S235, the UE 10 determines in addition the RS sets are associated with at least two TRP (e.g. two CORESETPoolIndex for mDCI scenario). This association determination can be executed, for example, via a predefined configuration or a configuration that is received from the communication network. For example, in S235, it is determined that set A1/B1 is related to CORESETPoolIndex 0 (TRP #1 20) and that set A2/B2 is related to CORESETPoolIndex 1 (TRP #2 25).

In S240, the network (i.e. TRP #1 20) triggers group-based beam reporting based on prediction via triggering aperiodic CSI reporting in DCI corresponding to the CSI-ReportConfig. Furthermore, in S250 and S255, the TRP #1 20 and the TRP #2 25 send corresponding RS sets. The RS can be sent, for example, in a periodic, semi-persistant or aperiodic manner. For example, the UE 10 receives CSI-RS (or SSBs) transmissions associated with set B1 from TRP #1 20 and set B2 from TRP #2 25.

In S260, the measurement module of the UE 10 measures, for example, the L1-RSRP or other suitable CSI quantities on the basis of the received CSI-RS (or SSBs). The UE 10 further determines beam pairs (or beam groups) for simultaneous reception (i.e. for multi-TRP reception).

In S270, the beam measurements (e.g. beam indices, together with further parameters, such as the measured L1-RSRP) and the identified beam pairs are used as an input for the prediction model.

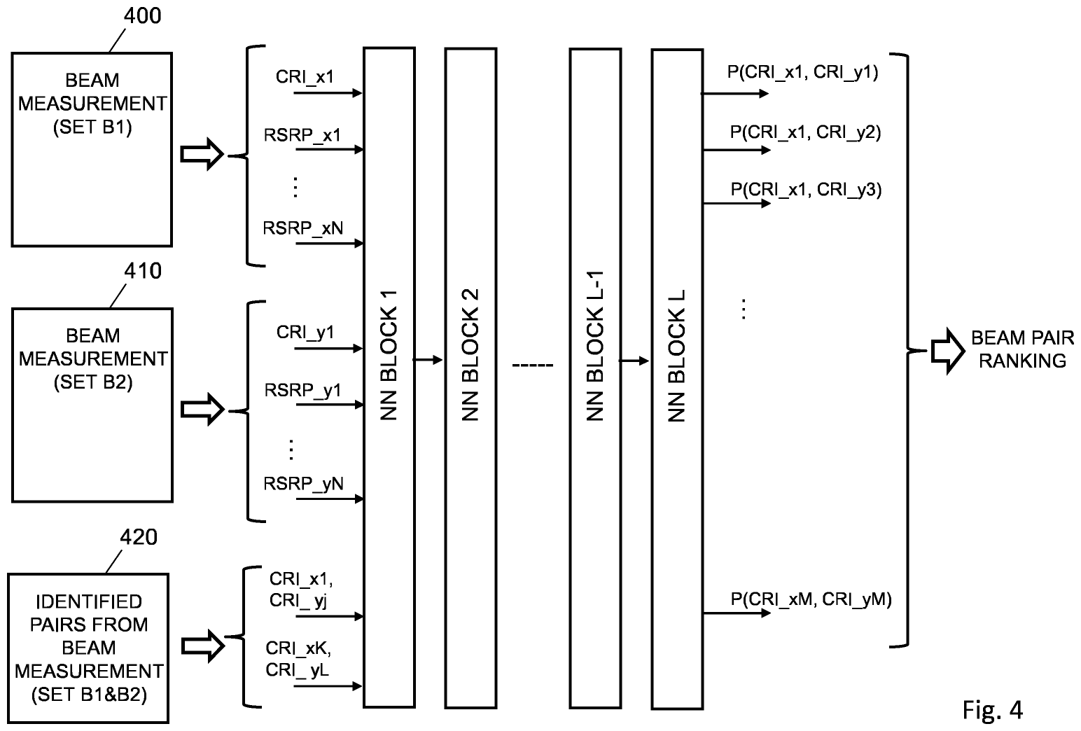

In S280, the UE 10 executes a group based beam prediction by using a prediction model (e.g. an AI/ML model) determined in S230. As inputs for the prediction model, data provided on the basis of the beam measurements in S260 corresponding to set B1 and set B2 are used. As a result of the prediction, for example, the best beam pairs (groups) for simultaneous reception considering set A1/B1 and set A2/B2 are determined. It is noted that an example of such an AI/ML prediction model is described below with regard to FIG. 4, for example.

In S290, an output of the prediction model including the determined best beam pairs and corresponding L1-RSRP is provided, for example, in a preset ranking order. The output is used in S295 by the UE to construct a reporting CSI feedback (as UL control information) according to the reporting quantities configured in the CSI-ReportConfig, which is used to report CSI quantities to the communication network (e.g. TRP #1 20).

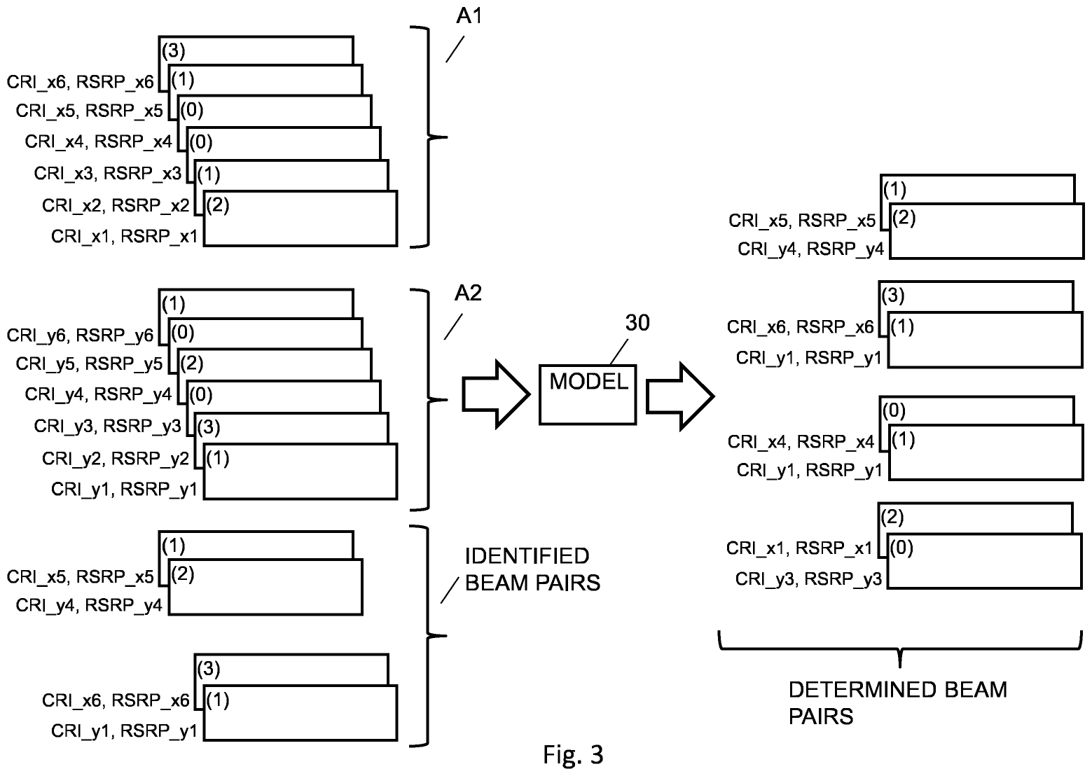

FIG. 3 shows further details regarding a beam measurement procedure according to examples of the disclosure. Specifically, FIG. 3 shows a procedure where multi-TRP operation is supported with a limited number of beam measurements from each TRP.

In FIG. 3, beams from TRP #1 20 and TRP #2 25 are depicted, wherein beam set A1 including six beams (indicated by CRI_x1, RSRP_x1 to CRI_x6, RSRP_x6) from TRP #1 20 and beam set A2 including six beams (indicated by CRI_y1, RSRP_y1 to CRI_y6, RSRP_y6) from TRP #2 25 are shown. It is assumed in the example of FIG. 3 that set B1 and set B2 are sub-sets of set A1 and set A2, respectively.

Beam measurements with no RSRP refer to the set B1 (e.g. CRI_x4, CRI_x3) and set B2 (e.g. CRI_y3, CRI_y5) corresponding to TRP #1 20 and TRP #2 25, respectively. It is to be noted that numbers indicated in brackets refer to an assumed relative strength of L1-RSRP for each measured beam (i.e. (0) to (3), wherein (0) represents a case with no RSRP, and (3) represents a case with high RSRP).

As shown in FIG. 3, two beam pairs are identified by the UE 10 based on beam measurements (e.g. CRI_x5, CRI_y4, and CRI_x6, CRI_y1). These beam pairs represent the identified beam pairs.

Reference sign 30 in FIG. 3 represents the prediction model. The input of the prediction model is provided by the beam measurements (i.e. identified beam pairs, beam indices, and L1-RSRP values). On the basis of the input, the prediction model 30 predicts more beam pairs and corresponding L1-RSRP for sets A1 and A2, which are indicated as the determined beam pairs usable for the simultaneous reception based on predictions (i.e., besides the identified beam pairs CRI_x5, CRI_y4, and CRI_x6, CRI_y1, also beam pairs CRI_x1, CRI_y3, and CRI_x4, CRI_y1, for example).

Next, FIG. 4 shows, as an example for a prediction model usable in connection with examples of the disclosure, a diagram of a NN design for spatial beam prediction according to examples of the disclosure. It is to be noted that FIG. 4 illustrates only one example of a usable prediction model. Generally, a prediction model being usable can be selected by the UE, e.g. on the basis of an implementation decision, wherein different approaches can be used for the prediction model by UEs, such as machine learning (ML) or non-machine learning (non-ML) based models, wherein the accuracy for prediction can be set variably.

As indicated in FIG. 4, as inputs for the prediction model, beam measurements 400 of set B1 and beam measurements 410 of set B2 are used. Furthermore, the identified beam pairs for beam measurement (from set B1 and set B2) are used.

The prediction model is configured by a plurality of NN blocks (NN block 1 to NN block L in FIG. 4). The NN Block 1 takes as input the beam measurements, considering CRI and RSRP measurements for each set of beams (set B1 and set B2) on the xi (i=1, . . . ,N) and yi (i=1, . . . ,N) CSI-RS resources and identified best beam pairs (xi, yj) (i, j select from within (i=1, . . . ,N)). Then, each internal NN block (2, . . . ,L−1) has nₕ neurons (i.e., the number of neurons), and finally the NN Block L has M output neurons corresponding to the CRI pairs (set A1 and set A2 resources, i.e., resource/beam pairs corresponding to xi, yj (i,j=1, . . . ,N) pairing).

It is to be noted that each NN block can include fully connected layers (FNN), activation function layers and batch normalization layers, as shown in FIG. 4. In this case, the information moves in the forward direction only from the input to the output blocks.

At the lth NN block, the output vector m^{l} is calculated with a non-linear activation function σ and can be expressed as

$${m}^{l} = σ ( {W}_{l}^{c} {m}^{l - 1} + {w}_{l}^{b} ) ,$$

where m^{l-1} is the output at the previous NN block,

$${W}_{l}^{c}$$

are the weights of the lth NN block and

$${w}_{l}^{b}$$

are the biases of the lth NN block. The weights,

$${W}_{l}^{c}$$

and biases

$${w}_{l}^{b}$$

forms the trainable parameters Wₗ of the lth NN block. The last output m^{L} corresponds to the output of the last NN block of the ML model and can be expressed using non-linear functions

$${g}_{{W}_{L}}^{( L )} , … , {g}_{{W}_{l}}^{( l )} , for l = 1 , … ,$$

L as a combination of the ML model input and trainable parameters of different NN blocks:

$${m}^{L} = {g}_{{W}_{L}}^{( L )} ( {g}_{{W}_{L - 1}}^{( L - 1 )} ( … {g}_{{W}_{1}}^{( 1 )} ( x ) ) ) .$$

The outputs of the network, m^{L}, is then passed to a SoftMax function, hence P_{y}=softmax(m^{L}), to obtain the probability distribution Pₘ over the set of ML model outputs.

Therefore, we consider ranking these probabilities, for instance, in descending order and selecting the best K beam pairs as follows:

$$f = {arg sort}_{m} {P}_{m}$$

$$ℒ = \{ {f}_{k} \vert k = 1 , … , K \}$$

where the set [symbol] includes the best K CRI/beam pairs.

According to examples of the disclosure, ML models (an example of which is illustrated in FIG. 4) can be trained with a stochastic gradient descent (SGD) algorithm, which computes the minimum of the loss function in the direction of the gradient with respect to the ML model weights Wₗ. Given nᵢ data samples from the training set formed by input data {X⁽¹⁾, X⁽²⁾, . . . , X⁽ⁿ^{ᵢ})} and corresponding labels m⁽ⁱ⁾. The SGD firstly computes gradient estimate

$$\hat{g} ← + \frac{1}{z} {∇}_{W} {\sum }_{i} Loss ( f ( {X}^{( i )} ; {W}_{i}^{t - 1} ) , {m}^{( i )} ) ,$$

then updates the weights

$${W}_{i}^{t} ← {W}_{i}^{t - 1} - η \hat{g}$$

(where η is the learning rate). SGD iterates these two steps until a stopping criterion is met.

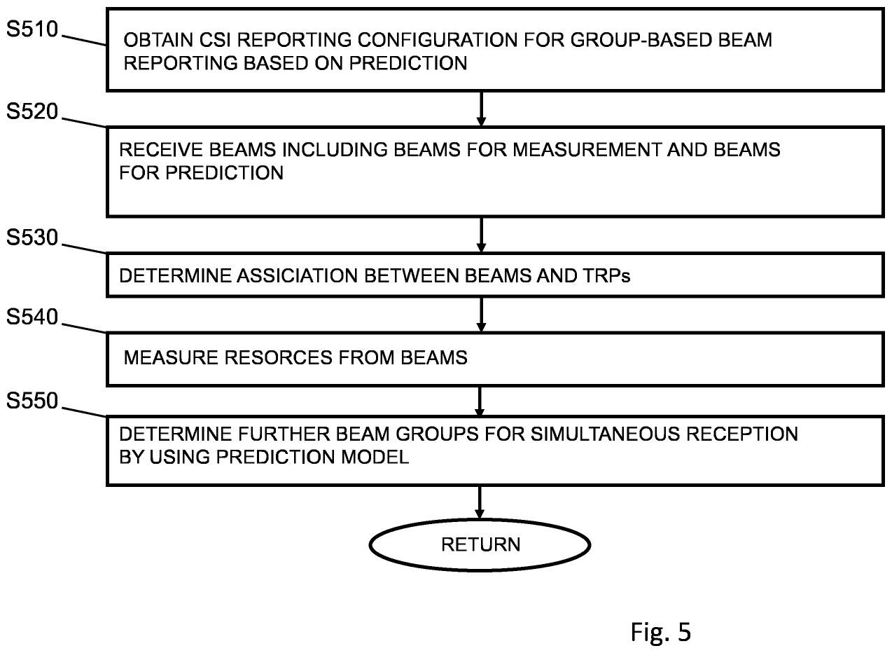

FIG. 5 shows a flow chart of a processing conducted in a communication element or communication function, such as a UE, according to some examples of the disclosure, wherein the communication element or communication function is capable of conducting multi TRP operation. That is, FIG. 5 shows a flowchart related to a processing conducted by a communication element or communication function, such as UE 10 as also described in connection with FIGS. 1 to 4. According to some examples of the disclosure, the UE has multiple reception panels for simultaneously receiving beams from a plurality of TRPs of the communication network.

In S510, the UE obtains CSI reporting configuration information for enabling group-based beam reporting based on prediction. According to some examples of the disclosure, for obtaining the CSI reporting configuration information, the UE reports beforehand to a TRP of the communication network a capability for supporting group-based beam reporting based on prediction, wherein the CSI reporting configuration information is received in response to the reporting of the capability.

In S520, the UE receives a plurality of beams comprising at least one set of beams for measurement (referred to above as set B) and at least one set of beams of prediction (referred to above as set A).

In S530, the UE determines an association of the received plurality of beams to a respective TRP of a communication network.

According to some examples of the disclosure, for determining the association of the received plurality of beams to a respective TRP of a communication network, the UE uses a predefined or received configuration indicating associations of received reference signals with at least two transmission points of the communication network.

In S540, the UE measures resources from the at least one set of beams for measurement for identifying beam groups for simultaneous reception.,

It is to be noted that according to some examples of the disclosure a beam is represented by a DL reference signal resource comprising at least one of a CSI RS and a SSB resource, wherein the DL signal resources are grouped into groups each corresponding to a respective TRP (e.g. TRP #1 20 or TRP #2 25, as described above).

Moreover, according to some examples of the disclosure, the at least one set of beams for measurement comprises downlink reference signals transmitted by a corresponding TRP, while the at least one set of beams for prediction comprises downlink reference signals not transmitted by a corresponding TRP.

According to some examples of the disclosure, a beam group forming the identified beam group or the further beam group comprises beams corresponding to two TRPs or spatial filters, wherein at least one beam corresponds to a one TRP or spatial filter and another beam corresponds to a another TRP or spatial filter. Alternatively, beam groups forming the identified beam group or the further beam group each comprise beams corresponding to only one TRP or spatial filter, wherein one sub-set of beams in each beam group is from the set of beams for measurement and another sub-set of beams in the beam group is determined from the set of beams for prediction.

According to some examples of the disclosure, as the resources from the at least one set of beams for measurement for identifying beam groups for simultaneous reception, at least one of a RSRP or a CSI quantity is measured on the basis of a signal transmission from the communication network, e.g. from the RS transmissions from the respective TRPs.

In S550, the UE determines further beam groups usable for simultaneous reception by using a prediction model. The further beam groups comprise beams of the at least one set of beams for measurement and the at least one set of beams for prediction.

According to some examples of the disclosure, in case a prediction based on the prediction model results in an output of at least one further beam group, the UE reports at least a part of the resulting further beam group in a predefined order to a TRP of the communication network. The predefined order reflects a suitability level of the reported further beam groups for simultaneous reception (e.g. in ascending or descending order of suitability).

According to some examples of the disclosure, when reporting at least a part of the resulting further beam group, the UE may include additional parameters indicating communication properties of beams of the at least one further beam group. The communication properties comprise, for example, at least one of a RSRP indication, a SINR, a reliability metric associated to the prediction model used, and an indication of a capability value set.

According to some examples of the disclosure, the prediction model used for determining the further beam groups usable for simultaneous reception is a machine learning prediction model using a neuronal network configuration having a plurality of NN blocks including at least one of a fully connected neuronal network block, an activation function layer and a batch normalization layer. Alternatively, the prediction model used for determining the further beam groups usable for simultaneous reception is a non-machine learning prediction model.

According to some examples of the disclosure, the UE uses, as input data of the prediction model, beam measurements and identified beam groups for simultaneous reception.

Moreover, according to some examples of the disclosure, the UE is configured to determine a prediction model which is to be applied on the basis of information provided by the obtained channel state information reporting configuration information. For example, a prediction model to be used is determined on the basis of signaling properties of RS from the network.

In addition, according to some examples of the disclosure, the UE reports at least a part of the determined further beam groups usable for simultaneous reception as uplink control information to the communication network.

According to some examples of the disclosure, the UE applies a spatial filter adjusted for receiving beams identified or determined to be usable for simultaneous reception.

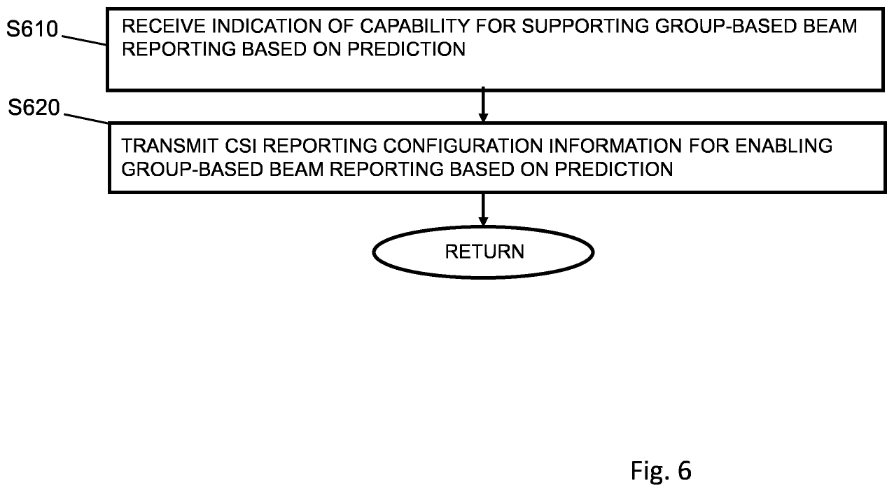

FIG. 6 shows a flow chart of a processing conducted in a communication network control element or communication network control function, such as a gNB used as a TRP (e.g. TRP #1 20) according to some examples of the disclosure. That is, FIG. 6 shows a flowchart related to a processing conducted by a communication network control element or communication network control function, such as TRP #1 20 as also described in connection with FIGS. 1 to 4.

In S610, the TRP receives an indication of a capability of a communication element or communication function for supporting group-based beam reporting based on prediction from a UE.

In S620, the TRP transmits, to the UE, CSI reporting configuration information for enabling group-based beam reporting based on prediction.

Furthermore, according to some examples of the disclosure, the TRP is configured to trigger group-based beam reporting based on prediction by triggering an aperiodic CSI reporting to the UE corresponding to the CSI reporting configuration information.

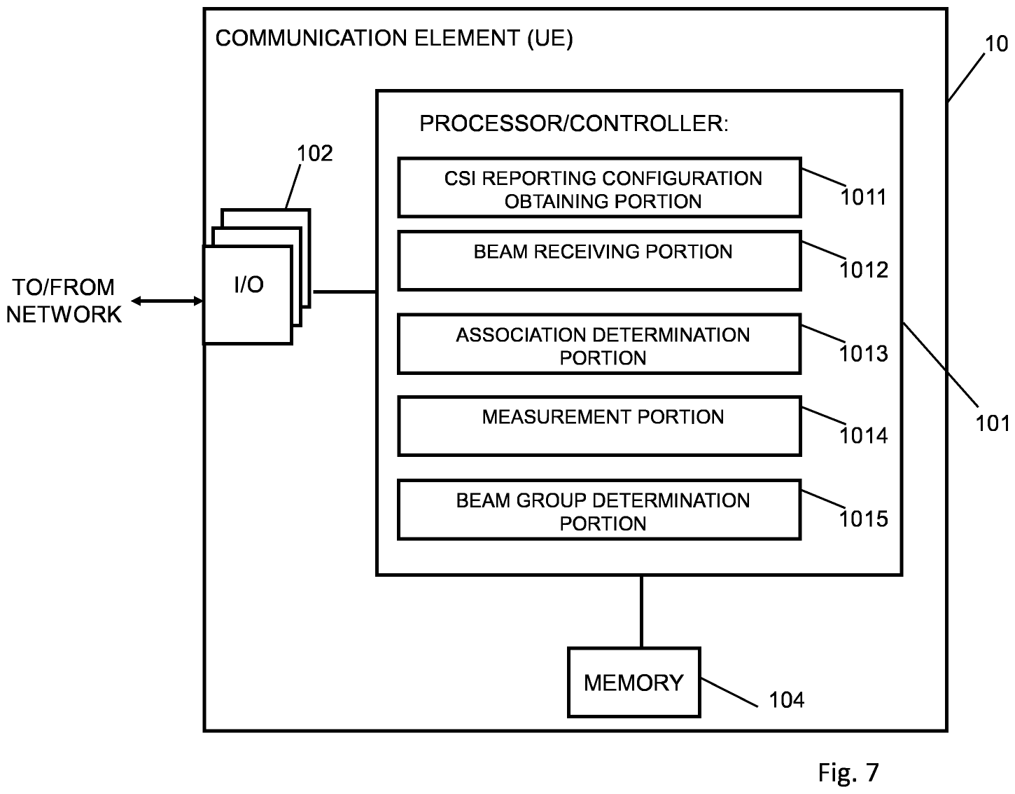

FIG. 7 shows a diagram of a communication element or communication function, such as UE 10, which conducts a processing according to some examples of the disclosure, as described in connection with FIGS. 1 to 4. It is to be noted that the network element or function such as the UE 10 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The UE 10 shown in FIG. 7 may include a processing circuitry, a processing function, a control unit or a processor 101, such as a CPU or the like, which is suitable for executing instructions given by programs or the like related to the control procedure. The processor 101 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 102 denotes input/output (I/O) units or functions (interfaces) connected to the processor or processing function 101. The I/O units 102 may be used for communicating with the communication network such as the TRPs 20 and 25. The I/O unit 102 may be combined units including communication equipment towards several entities, or may include a distributed structure with a plurality of different interfaces for different entities. Reference sign 104 denotes a memory usable, for example, for storing data and programs to be executed by the processor or processing function 101 and/or as a working storage of the processor or processing function 101. It is to be noted that the memory 104 may be implemented by using one or more memory portions of the same or different type of memory.

The processor or processing function 101 is configured to execute processing related to the above described control procedure. In particular, the processor or processing circuitry or function 101 includes one or more of the following sub-portions. Sub-portion 1011 is a processing portion which is usable as a portion for obtaining a CSI reporting configuration. The portion 1011 may be configured to perform processing according to S510 of FIG. 5. Furthermore, the processor or processing circuitry or function 101 may include a sub-portion 1012 usable as a portion for receiving beams. The portion 1012 may be configured to perform a processing according to S520 of FIG. 5. In addition, the processor or processing circuitry or function 101 may include a sub-portion 1013 usable as a portion for determining associations. The portion 1013 may be configured to perform a processing according to S530 of FIG. 5. Moreover, the processor or processing circuitry or function 101 may include a sub-portion 1014 usable as a portion for measurement. The portion 1014 may be configured to perform a processing according to S540 of FIG. 5. Furthermore, the processor or processing circuitry or function 101 may include a sub-portion 1015 usable as a portion for determining beam groups. The portion 1015 may be configured to perform a processing according to S550 of FIG. 5.

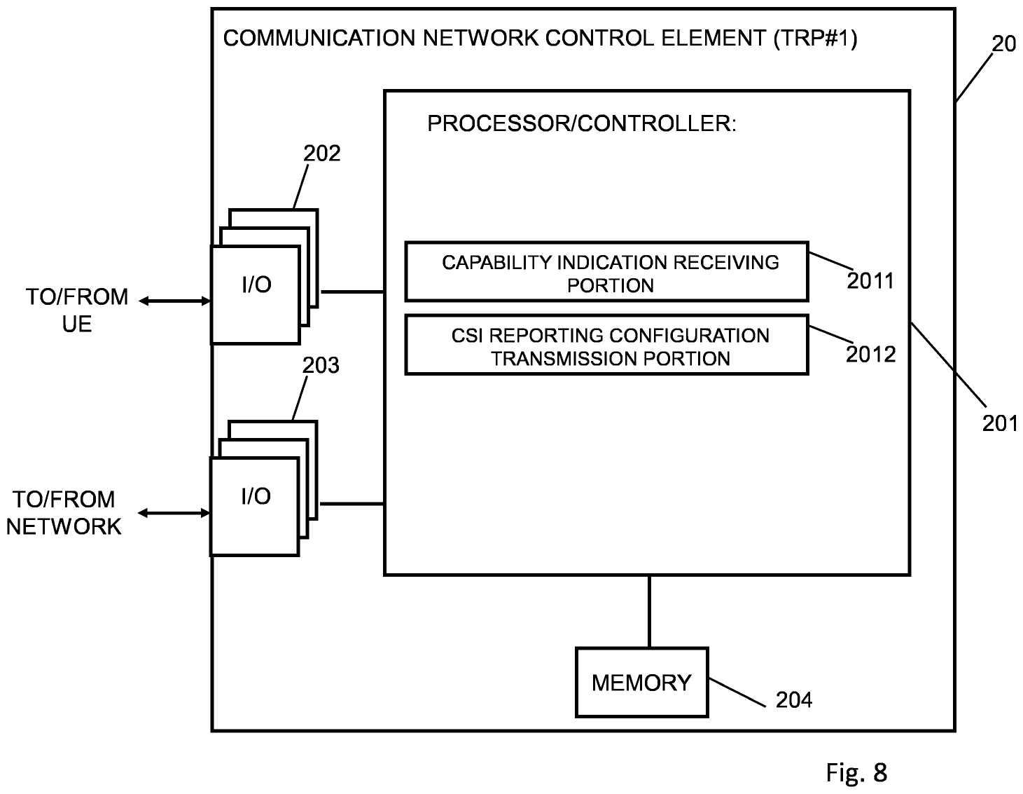

FIG. 8 shows a diagram of a communication network control element or communication network control function, such as a gNB being a TRP (e.g. TRP #1 20), which conducts a communication control according to some examples of the disclosure, as described in connection with FIGS. 1 to 4. It is to be noted that the network element or function such as the TRP 20 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The TRP 20 shown in FIG. 8 may include a processing circuitry, a processing function, a control unit or a processor 201, such as a CPU or the like, which is suitable for executing instructions given by programs or the like related to the control procedure. The processor 201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 202 and 203 denotes input/output (I/O) units or functions (interfaces) connected to the processor or processing function 201. The I/O units 202 may be used for communicating with a communication element or communication function, such as the UE, as shown in FIG. 1. The I/O units 203 may be used for communicating with other network functions. The I/O units 202 and 203 may be combined units including communication equipment towards several entities, or may include a distributed structure with a plurality of different interfaces for different entities. Reference sign 204 denotes a memory usable, for example, for storing data and programs to be executed by the processor or processing function 201 and/or as a working storage of the processor or processing function 201. It is to be noted that the memory 204 may be implemented by using one or more memory portions of the same or different type of memory.

The processor or processing function 201 is configured to execute processing related to the above described control procedure. In particular, the processor or processing circuitry or function 201 includes one or more of the following sub-portions. Sub-portion 2011 is a processing portion which is usable as a portion for receiving a capability indication. The portion 2011 may be configured to perform processing according to S610 of FIG. 6. Furthermore, the processor or processing circuitry or function 201 may include a sub-portion 2012 usable as a portion for sending a CSI reporting configuration. The portion 2012 may be configured to perform a processing according to S620 of FIG. 6.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operation environment may be used in connection with examples of embodiments of the disclosure based on the principles defined.

Furthermore, even though in the above examples of embodiments mainly a UE is described as a communication element or communication function for which the proposed control procedure is applied, examples of embodiments may concern also other communication elements or communication functions for which a corresponding processing is applicable.

According to a further example of embodiments, there is provided, for example, an apparatus for use by a communication element or communication function capable of conducting multi transmission and reception point, TRP, operation, the apparatus comprising means configured to obtain channel state information reporting configuration information for enabling group-based beam reporting based on prediction, means configured to receive a plurality of beams comprising at least one set of beams for measurement and at least one set of beams of prediction, means configured to determine an association of the received plurality of beams to a respective TRP of a communication network, means configured to measure resources from the at least one set of beams for measurement for identifying beam groups for simultaneous reception, and means configured to determine further beam groups usable for simultaneous reception by using a prediction model, wherein the further beam groups comprise beams of the at least one set of beams for measurement and the at least one set of beams for prediction.

Furthermore, according to some other examples of embodiments, the above defined apparatus may further comprise means for conducting at least one of the processing defined in the above described methods, for example a method according to that described in connection with FIG. 5.

According to a further example of embodiments, there is provided, for example, an apparatus for use by a communication network control element or communication network control function acting as a transmission and reception point, TRP, for communicating with a communication element or communication function, the apparatus comprising means configured to receive an indication of a capability of a communication element or communication function for supporting group-based beam reporting based on prediction, and means configured to transmit, to the communication element or communication function, channel state information reporting configuration information for enabling group-based beam reporting based on prediction.

Furthermore, according to some other examples of embodiments, the above defined apparatus may further comprise means for conducting at least one of the processing defined in the above described methods, for example a method according to that described in connection with FIG. 5.

According to a further example of embodiments, there is provided, for example, a non-transitory computer readable medium comprising program instructions for causing an apparatus to perform, when used in in a communication element or communication function capable of conducting multi transmission and reception point, TRP, operation, a processing comprising obtaining channel state information reporting configuration information for enabling group-based beam reporting based on prediction, receiving a plurality of beams comprising at least one set of beams for measurement and at least one set of beams of prediction, determining an association of the received plurality of beams to a respective TRP of a communication network, measuring resources from the at least one set of beams for measurement for identifying beam groups for simultaneous reception, and determining further beam groups usable for simultaneous reception by using a prediction model, wherein the further beam groups comprise beams of the at least one set of beams for measurement and the at least one set of beams for prediction.

According to a further example of embodiments, there is provided, for example, a non-transitory computer readable medium comprising program instructions for causing an apparatus to perform, when used in in a communication network control element or communication network control function acting as a transmission and reception point, TRP, for communicating with a communication element or communication function, a processing comprising receiving an indication of a capability of a communication element or communication function for supporting group-based beam reporting based on prediction, and transmitting, to the communication element or communication function, channel state information reporting configuration information for enabling group-based beam reporting based on prediction.

By means of the above described configuration, it is possible to reduce an RS overhead and a latency in the beam measurement and reporting.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C #, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1.-37. (canceled)

38. An apparatus, comprising:
at least one processing circuitry, and
at least one memory for storing instructions that, when executed by the at least one processing circuitry, cause the apparatus at least
to obtain channel state information reporting configuration information for enabling group-based beam reporting based on prediction,
to receive a plurality of beams comprising at least one set of beams for measurement and at least one set of beams of prediction,
to determine an association of the received plurality of beams to a respective transmission and reception point (TRP) of a communication network,
to measure resources from the at least one set of beams for measurement for identifying beam groups for simultaneous reception,
to determine further beam groups usable for simultaneous reception by using a prediction model, wherein the further beam groups comprise beams of the at least one set of beams for measurement and the at least one set of beams for prediction.

39. The apparatus according to claim 38, wherein the instructions further cause the apparatus at least:
in case a prediction based on the prediction model results in an output of at least one further beam group, to report at least a part of the resulting further beam group in a predefined order to a TRP of the communication network, wherein the predefined order reflects a suitability level of the reported further beam groups for simultaneous reception.

40. The apparatus according to claim 39, wherein the instructions further cause the apparatus at least:
when reporting at least a part of the resulting further beam group, to include additional parameters indicating communication properties of beams of the at least one further beam group, wherein the communication properties comprises at least one of a reference signal received power indication, a signal to interference plus noise ratio, a reliability metric associated to the prediction model used, and an indication of a capability value set.

41. The apparatus according to claim 40, wherein the instructions further cause the apparatus at least:
to report, to a TRP of the communication network, a capability for supporting group-based beam reporting based on prediction, wherein the channel state information reporting configuration information is received in response to the reporting of the capability.

42. The apparatus according to claim 40, wherein the instructions further cause the apparatus at least:
for determining the association of the received plurality of beams to a respective TRP of a communication network, to use a predefined or received configuration indicating associations of received reference signals with at least two transmission points of the communication network.

43. The apparatus according to claim 40, wherein
a beam is represented by a downlink reference signal resource comprising at least one of a channel state information reference signal and a synchronization signal block resource, wherein the downlink reference signal resources are grouped into groups each corresponding to a respective TRP.

44. The apparatus according to claim 40, wherein
the at least one set of beams for measurement comprises downlink reference signals transmitted by a corresponding TRP, and
the at least one set of beams for prediction comprises downlink reference signals not transmitted by a corresponding TRP.

45. The apparatus according to claim 40, wherein
a beam group forming the identified beam group or the further beam group comprises one of:
a) beams corresponding to two TRPs or spatial filters, wherein at least one beam corresponds to a one TRP or spatial filter and another beam corresponds to a another TRP or spatial filter, or
b) beams corresponding to only one TRP or spatial filter, wherein one sub-set of beams in the beam group are from the set of beams for measurement and another sub-set of beams in the beam group is determined from the set of beams for prediction.

46. The apparatus according to claim 40, wherein the instructions further cause the apparatus at least:
to measure, as the resources from the at least one set of beams for measurement for identifying beam groups for simultaneous reception, at least one of a reference signal received power or a channel state information quantity on the basis of a signal transmission from the communication network.

47. A method for communication, comprising:
obtaining channel state information reporting configuration information for enabling group-based beam reporting based on prediction,
receiving a plurality of beams comprising at least one set of beams for measurement and at least one set of beams of prediction,
determining an association of the received plurality of beams to a respective transmission and reception point (TRP) of a communication network,
measuring resources from the at least one set of beams for measurement for identifying beam groups for simultaneous reception, and
determining further beam groups usable for simultaneous reception by using a prediction model, wherein the further beam groups comprise beams of the at least one set of beams for measurement and the at least one set of beams for prediction.

48. The method according to claim 47, further comprising
in case a prediction based on the prediction model results in an output of at least one further beam group, reporting at least a part of the resulting further beam group in a predefined order to a TRP of the communication network, wherein the predefined order reflects a suitability level of the reported further beam groups for simultaneous reception.

49. The method according to claim 48, further comprising
when reporting at least a part of the resulting further beam group, including additional parameters indicating communication properties of beams of the at least one further beam group, wherein the communication properties comprises at least one of a reference signal received power indication, a signal to interference plus noise ratio, a reliability metric associated to the prediction model used, and an indication of a capability value set.

50. The method according to claim 47, further comprising
reporting, to a TRP of the communication network, a capability for supporting group-based beam reporting based on prediction, wherein the channel state information reporting configuration information is received in response to the reporting of the capability.

51. The method according to claim 47, further comprising
for determining the association of the received plurality of beams to a respective TRP of a communication network, using a predefined or received configuration indicating associations of received reference signals with at least two transmission points of the communication network.

52. The method according to claim 47, wherein
a beam is represented by a downlink reference signal resource comprising at least one of a channel state information reference signal and a synchronization signal block resource, wherein the downlink reference signal resources are grouped into groups each corresponding to a respective TRP.

53. The method according to claim 47, wherein
the at least one set of beams for measurement comprises downlink reference signals transmitted by a corresponding TRP, and
the at least one set of beams for prediction comprises downlink reference signals not transmitted by a corresponding TRP.

54. The method according to claim 47, wherein
a beam group forming the identified beam group or the further beam group comprises one of:
a) beams corresponding to two TRPs or spatial filters, wherein at least one beam corresponds to a one TRP or spatial filter and another beam corresponds to a another TRP or spatial filter, or
b) beams corresponding to only one TRP or spatial filter, wherein one sub-set of beams in the beam group are from the set of beams for measurement and another sub-set of beams in the beam group is determined from the set of beams for prediction.

55. The method according to claim 47, further comprising measuring, as the resources from the at least one set of beams for measurement for identifying beam groups for simultaneous reception, at least one of a reference signal received power or a channel state information quantity on the basis of a signal transmission from the communication network.

56. A non-transitory computer readable medium comprising program instructions for causing an apparatus to perform:
obtaining channel state information reporting configuration information for enabling group-based beam reporting based on prediction,
receiving a plurality of beams comprising at least one set of beams for measurement and at least one set of beams of prediction,
determining an association of the received plurality of beams to a respective transmission and reception point (TRP) of a communication network,
measuring resources from the at least one set of beams for measurement for identifying beam groups for simultaneous reception, and
determining further beam groups usable for simultaneous reception by using a prediction model, wherein the further beam groups comprise beams of the at least one set of beams for measurement and the at least one set of beams for prediction.

57. The non-transitory computer readable medium according to claim 56, wherein the instructions further causing the apparatus to perform:
in case a prediction based on the prediction model results in an output of at least one further beam group, reporting at least a part of the resulting further beam group in a predefined order to a TRP of the communication network, wherein the predefined order reflects a suitability level of the reported further beam groups for simultaneous reception.
